(19) United States
(12) Patent Application Publication
(10) Pub. No.: US 2018/0087796 A1
(43) Pub. Date: Mar. 29, 2018

(54) METHOD OF EXTRACTING DIAGNOSTIC INFORMATION FROM AN HVAC SYSTEM

(71) Applicant: Trane International Inc., Davidson, NC (US)

(72) Inventors: Daniel John Blair, Tyler, TX (US); Bradley T. Wilson, Tyler, TX (US)

(73) Assignee: Trane International Inc., Davidson, NC (US)

(21) Appl. No.: 15/713,152

(22) Filed: Sep. 22, 2017

Related U.S. Application Data
(60) Provisional application No. 62/399,653, filed on Sep. 26, 2016.

(51) Int. Cl. F24F 11/00; G05D 23/19

(52) U.S. Cl. CPC F24F 11/0086; F24F 11/006; G05D 23/1902; F24F 2011/0071; F24F 2011/0091; F24F 2011/0067; G05D 23/19

(57) ABSTRACT

The present disclosure is directed to a method for determining the operational state of an HVAC system. The method includes transmitting diagnostic data and/or commissioning settings to and from an HVAC system and server by means of a mobile device, comparing the data to a predetermined condition, and transmitting updated system information back to the HVAC system if needed.

### CROSS-REFERENCE TO RELATED APPLICATION

This application claims the benefit of and priority to U.S. Provisional Application Ser. No. 62/399,653 entitled “METHOD OF EXTRACTING DIAGNOSTIC INFORMATION FROM AN HVAC SYSTEM” and filed Sep. 26, 2016, the entirety of which is hereby incorporated by reference herein for all purposes.

### BACKGROUND

### 1. Technical Field

The present disclosure is related to HVAC systems, and in particular, to control and communication systems for HVAC systems.

### 2. Background of Related Art

Heating, ventilation, and air conditioning systems (HVAC systems) typically utilize one or more sensors, thermostats, and/or HVAC controllers. These electronics are commonly used to monitor environmental conditions in a building and to operate HVAC equipment installed at the building. Despite advances in HVAC technology, there are still many aspects of HVAC systems which can be improved. This disclosure provides improvements for HVAC systems.

### SUMMARY

In one aspect, the present disclosure is directed to a method for receiving commissioning settings and diagnostic data from a HVAC system at a server, and populating a database stored on the server with the commissioning settings and the diagnostic data from the HVAC system.

In another aspect, the method may include correlating the commissioning settings and the diagnostic data with existing operational data in the database to determine an operational condition of the HVAC system.

In another aspect, the method may include transmitting updated commissioning settings from the server.

In accordance with at least one aspect of this disclosure, a method for establishing a connection between a mobile device and a HVAC system, receiving commissioning settings and diagnostic data at the mobile device from the HVAC system, and transmitting the commissioning settings and diagnostic data from the mobile device to a server.

In another aspect, the method may include receiving updated commissioning settings from the server.

In another aspect, the method may include transmitting the updated commissioning settings from the mobile device to the HVAC system.

In another aspect, the method may include notifying the user of updated settings at the mobile device.

In another aspect, the method can include prompting a user for approval to transmit the updated commissioning settings at the mobile device.

In another aspect, the method may include displaying on the mobile device the commissioning settings and/or diagnostic data.

In another aspect, establishing a connection includes establishing a connection between the mobile device and a removable dongle connected to the HVAC system.

In accordance with another aspect of this disclosure, a system for a server includes a processor and memory. The processor is configured to execute computer readable instructions stored on the memory. The instructions include receiving commissioning settings and diagnostic data from a HVAC system at the server, populating a database stored on the server with the commissioning settings, and the diagnostic data from the HVAC system.

In another aspect, the instructions can include correlating the commissioning settings and the diagnostic data with existing operational data in the database to determine an operational condition of the HVAC system.

In another aspect, the instructions can include transmitting updated commissioning settings from the server.

In accordance with at least one aspect of this disclosure, a non-transitory computer readable medium includes computer executable instructions. The instructions include establishing a connection between a mobile device and a HVAC system, receiving commissioning settings and diagnostic data from the HVAC system, and transmitting commissioning settings and diagnostic data from the mobile device to a server.

In another aspect, the computer executable instructions can include receiving updated commissioning settings from the server.

In another aspect, the computer executable instructions can include transmitting updated commissioning settings from the mobile device to the HVAC system.

In another aspect, establishing a connection to the HVAC system can include establishing a connection between the mobile device and a removable dongle connected to the HVAC system.

In another aspect, the computer executable instructions can include notifying the user of updated commissioning settings at the mobile device.

In another aspect, the computer executable instructions can include prompting a user for approval to transmit the updated commissioning settings at the mobile device.

In another aspect, the computer executable instructions can include displaying on the mobile device the commissioning settings and/or diagnostic data.

In accordance with at least one aspect of this disclosure, an HVAC system can include a plurality of HVAC components. A controller for an HVAC system can include a data aggregation module configured to receive commissioning settings and diagnostic data from the plurality of HVAC components, and a removable dongle interface configured to receive a removable dongle for transmitting the commissioning settings and the diagnostic data to a mobile device.

In another aspect, the removable dongle interface can include a wired connection.

In another aspect, the removable dongle interface can include a wireless receiver.

In another aspect, the controller may include a settings update module for receiving updated commissioning settings from the mobile device and for pushing the updated commissioning settings to at least one of the plurality of HVAC components.

In another aspect, the controller may include the removable dongle.

### BRIEF DESCRIPTION OF THE DRAWINGS

Various embodiments of the disclosed system and method are described herein with reference to the drawings wherein:

FIG. 1 is a schematic diagram of an embodiment of a system in accordance with the present disclosure;

FIG. 2 is a flow chart of an embodiment of a method in accordance with the present disclosure;

FIG. 3 is a schematic diagram of an embodiment of a server in accordance with the present disclosure;

FIG. 4 is a flow chart of an embodiment of a method in accordance with the present disclosure; and

FIG. 5 is a schematic diagram of an embodiment of a controller in accordance with this disclosure.

The various aspects of the present disclosure mentioned above are described in further detail with reference to the aforementioned figures and the following detailed description of exemplary embodiments.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure is described herein in terms of functional block components and various processing steps. It should be appreciated that such functional blocks and/or processing steps may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed by any device, on a variety of operating systems, including without limitation RTOS, Apple OSX®, Apple iOS®, Google Android®, HP WebOS®, Linux, UNIX®, Microsoft Windows®, and/or Microsoft Windows Mobile®.

It should be appreciated that the particular implementations described herein are illustrative of the disclosure and its best mode and are not intended to otherwise limit the scope of the present disclosure in any way. Examples are presented herein which may include data items which are intended as examples and are not to be construed as limiting. Indeed, for the sake of brevity, conventional data networking, application development and other functional aspects of the systems (and components of the individual operating components of the systems) may not be described in detail herein. It should be noted that many alternative or additional functional relationships or physical or virtual connections may be present in a practical electronic system or apparatus. In the discussion contained herein, the terms user interface element and/or button are understood to be non-limiting, and include other user interface elements such as, without limitation, pushbutton, a proximity sensor, a hyperlink, clickable image, and the like.

As will be appreciated by one of ordinary skill in the art, aspects of the present disclosure may be embodied as a method, a data processing system, a device for data processing, and/or a computer program product. Certain aspects of the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., EEPROM, mask ROM, flash memory, USB thumb drives) and/or the like.

Computer program instructions embodying certain aspects of the present disclosure may also be stored in a computer-readable memory that may direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security and/or any other suitable reason, any components, data structures, and communications links may include any of various suitable security features, such as firewalls, access codes, encryption, de-encryption, compression, decompression, and/or the like. In some instances, the steps recited herein may be executed in any order and are not limited to the order presented.

Certain embodiments are disclosed herein which operate in accordance with the ZigBee® wireless mesh networking standards, however, it should be understood that embodiments of the present disclosure are applicable to any wired or wireless network architecture, including without limitation Z-Wave®, in which the features and advantages discussed herein may be advantageously employed.

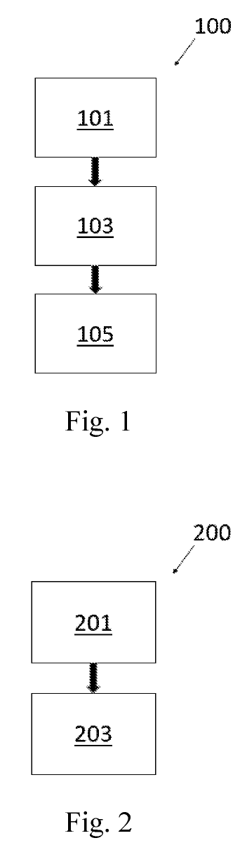

Referring to FIG. 1, a system 100 can include an HVAC system 101 (or any suitable component thereof) configured to communicate (e.g., wirelessly) with a mobile device 103. The mobile device 103 can connect with a server 105 to send and/or receive data therefrom.

Referring additionally to FIG. 2, in accordance with the present disclosure, a method 200 includes receiving (e.g., at block 201) commissioning settings (e.g., blower speed settings, temperature control hysteresis, compressor speed settings, airflow, outdoor unit tonnage) from the HVAC system 101 at the server 105. The method 200 can alternatively or conjunctively include receiving (e.g. at block 201) diagnostic data (e.g., which describes an operational condition of one or more components of the HVAC system 101 such as, but not limited to refrigerant system temperature and pressures, system operating currents/voltages) from the HVAC system 101 at the server 105.

Table 1 below shows certain non-limiting examples of commissioning settings. Tables 2 and 3 below show certain non-limiting examples of diagnostic data (indoor and outdoor).

TABLE 1

| Name | Description |
|---|---|
| Indoor Unit Type | Air Handler or Furnace |
| Indoor unit capacity | Cooling or heating capacity in BTUs |
| EVC Included | Expansion Valve or TXV |
| CDA Included | Communicating display assembly is installed |
| EH accessory included | Electric heat is installed |
| HH accessory Included | Hydronic Heat function is installed |
| Airflow Method | CFM (cubic feet per minute) or CTM (constant torque |
| | mode) |
| EH Airflow multiplier | Airflow factor to adjust airflow so that electric heat can be |
| | used in different model air handlers |
| EH capacity | Electric heat KW capacity |
| EH airflow | Electric heat airflow |
| EH stages | # of stages for electric heat |
| Gas heat capacity | Furnace heating capacity |
| Gas heat stages | # of stages for furnace heating |
| Gas heating blower airflow | Set of values to be populated as options in display. |
| Gas heat stage multiplier | To be used in airflow calculations |
| Gas heat on blower delay | TBD Single value, model dependent |
| Gas heat off blower delay | TBD Set of values to be populated as options in display. |
| EEV Sensors Type | Sensor type available for EVC |
| EVC Configuration Group | Configuration group to be communicated to EVC on |
| Number | power-up. |
| EEV Open position | Position for valve all the way open |
| EEV Close position | Minimum position for valve closed |
| Continuous Fan multiplier | Blower airflow multiplier for continuous fan mode |
| Dehumidification multiplier | Blower airflow multiplier for dehumidification |
| AC airflow rated | Rated outdoor unit airflow setting. |
| (CFM/Ton) | |
| HP airflow rated | Rated outdoor unit airflow setting for heat pump |
| (CFM/Ton) | |
| Enhanced profile delay - | Blower turn on ramping, Pre-run, short-run and off delay |
| AC | along with timing for each. |
| Enhanced profile delay - | Blower turn on ramping, Pre-run, short-run and off delay |
| HP | along with timing for each. |
| ESPrated (External static | External Static Pressure specified in the rating rules for |
| pressure) | each rated OD unit capacity (Ton) match: |
| Motor Power Range | Blower motor power in horsepower for given unit model |
| Motor Rotation Direction | The blower motor shaft direction as seen from the motor |
| | lead end. Clockwise or counter clockwise. |
| Maximum Airflow | Maximum airflow that the AFC allows as input to Torque |
| | or CFM airflow control algorithm |
| Maximum Speed | Maximum rpm limit for the blower motor |
| Minimum Torque | Minimum torque for the blower motor |
| Motor Parameters | Information related to controlling motors from different |
| | manufacturers and motors with different power ratings. |
| Proportional gain value | Factor to control adjustment in rpm of Constant CFM |
| | airflow algorithm |
| Integral gain value Kᵢ | Integral gain factor which can be adjusted to tune motor |
| | controller response |
| Wₘₐₓ | Maximum motor application speed |
| Blower Motor | Blower Motor manufacturer ID number and motor |
| Manufacturer ID | horsepower |
| Minimum Speed | Minimum rpm limit for the blower motor |
| Maximum Torque | Maximum torque limit for the blower motor |
| Continuous fan + | Blower acceleration for continuous fan and compressor |
| compressor mode blower | heat and cool modes. |
| parameters | |
| Aux Heat blower slew rate | Blower acceleration time for auxiliary heat mode - gas or |
| | EH or HH |
| Wₙₐₘₑₚₗₐₜₑ | Motor nameplate maximum speed |
| CFM Blower Coefficients | Constant CFM coefficients for motors and different |
| | cabinet sizes |
| ESP_Static Coefficients | ESP coefficients or parameters for measuring static |
| | pressure |
| Software release ID | software identification |
| External switch | defines type of external switch and appropriate response to |
| | switch input |
| Heating maximum RPM | Heatpump, maximum compressor speed for outdoor unit |
| Minimum airflow | Minimum airflow for indoor |
| PFC (power factor | Active power factor correction, on or off |
| correction) | |
| Indoor air heating | Can select comfort or efficiency for indoor heating |
| Defaults | Restore |

TABLE 2
Indoor Variables

| | Variable Name | | |
|---|---|---|---|
| Variable Name | Revised | Variable Description | Data Type |
| dPa | ID_DeltaPressure | Air Pressure Rise (inH2O) | DECIMAL (1, 2) |
| Tidc | ID_CoilTemp | ID coil temp. (F.) | DECIMAL (3, 1) |
| Tidci | ID_CoilInletTemp | ID coil inlet temp. (F.) | DECIMAL (3, 1) |
| Tidg | ID_GasTemp | ID gas line temp. (F.) | DECIMAL (3, 1) |
| Tidra | ID_ReturnAirTemp | ID return air temp. (F.) | DECIMAL (3, 1) |
| Tidsa | ID_SupplyAirTemp | ID supply air temp. (F.) | DECIMAL (3, 1) |
| Tidl | ID_LiquidTemp | ID liquid line temp. (F.) | DECIMAL (3, 1) |
| Tidaa | ID_AmbientTemp | ID ambient temp. (F.) | DECIMAL (3, 1) |
| Cond_Sw | ID_CondensateSw | Condensate Switch | BOOLEAN |
| Iblower | ID_BlowerCurrent | Blower motor current (A) | DECIMAL (2, 1) |
| G | ID_G | Fan signal | BOOLEAN |
| BK | ID_BK | Fan speed | INTEGER |
| Y1_id | ID_Y1 | Compressor signal, 1st stage | BOOLEAN |
| | | (as sensed at ID unit) | |
| Y2_id | ID_Y2 | Compressor signal, 2nd stage | BOOLEAN |
| | | (as sensed at ID unit) | |
| W1 | ID_W1 | Heating signal, 1st stage | BOOLEAN |
| W2 | ID_W2 | Heating signal, 2nd stage | BOOLEAN |
| W3 | ID_W3 | Heating signal, 3rd stage | BOOLEAN |
| O_id | ID_O | SOV signal (HP only) (as | BOOLEAN |
| | | sensed at ID unit) | |

TABLE 3
Outdoor Variables

| Variable | Variable Name | | |
|---|---|---|---|
| Name | Revised | Variable Description | Data Type |
| Todc | OD_CoilTemp | OD coil temp. (F.) | DECIMAL (3, 1) |
| Todl | OD_LiquidTemp | OD liquid line temp. (F.) | DECIMAL (3, 1) |
| Tsuc | OD_CmprSucTemp | Compressor suction temp. (F.) | DECIMAL (3, 1) |
| Todaa | OD_AmbientTemp | OD ambient temp. (F.) | DECIMAL (3, 1) |
| Todda | OD_DischargeTemp | OD discharge air temp. (F.) | DECIMAL (3, 1) |
| Podl | OD_LiquidPressure | OD liquid line pressure (psig) | DECIMAL (3, 1) |
| Podg | OD_GasPressure | OD gas line pressure (psig) | DECIMAL (3, 1) |
| Icomp | OD_CmprCurrent | Compressor motor current (A) | DECIMAL (2, 1) |
| Ifan | OD_FanCurrent | Fan motor current (A) | DECIMAL (2, 1) |
| Y1_od | OD_Y1 | Compressor signal, 1st stage (as | BOOLEAN |
| | | sensed at OD unit) | |
| Y2_od | OD_Y2 | Compressor signal, 2nd stage (as | BOOLEAN |
| | | sensed at OD unit) | |
| O_od | OD_SOVPosition | SOV signal (as sensed at OD unit) | BOOLEAN |

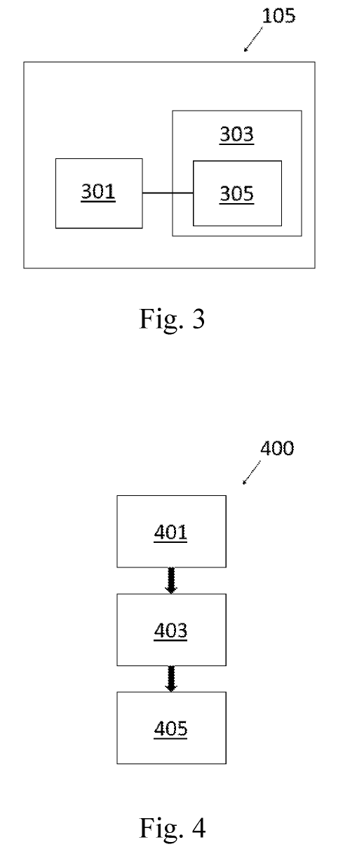

Referring additionally to FIG. 3, the server 105 can include a processor 301, memory 303, and a database 305 stored on the server 105 in the memory 303. The method 200 further includes populating (e.g., at block 203) the database 305 with the commissioning settings and/or the diagnostic data received from the HVAC system 101.

In certain embodiments, the method 200 can include correlating commissioning settings and/or the diagnostic data with existing operational data stored in the database 305. For instance, the database 305 can contain predetermined system settings that are correlated with the expected operational data. The server 105 can compare the received diagnostic data and/or commissioning settings with the existing operational data stored on the database 305 to determine if the HVAC system 101 is operating normally. In certain embodiments, the server 105 can formulate and/or transmit corrected commissioning settings (e.g., to a mobile device that is connected to the HVAC system) based on the comparison of the received diagnostic data and/or commissioning settings and the existing operational data.

Referring to FIGS. 1 and 4, in accordance with the present disclosure, a method 400 includes establishing a connection (e.g., at block 401) between a mobile device 103 and an HVAC system 101. Establishing a connection (e.g., at block 401) can include utilizing any suitable wired or wireless connections (e.g., wifi, bluetooth, cellular, satellite, etc.).

For example, one or more components (e.g., a controller, an outdoor component such as a condenser) of the HVAC system 101 can include a wireless transmitter/receiver for connecting to the mobile device 103. In certain embodiments, establishing a connection (e.g., at block 401) can include establishing a connection between the mobile device 103 and a removable dongle (e.g., as described below) connected to the HVAC system 101.

The method 400 also includes receiving (e.g., at block 403) commissioning settings and/or diagnostic data at the mobile device 103 from the HVAC system 101 and transmitting (e.g., at block 405) the commissioning settings and diagnostic data from the mobile device 103 to a server 105. The mobile device 103 can include any suitable mobile device (e.g., a smartphone, a laptop, a tablet).

The method 400 may include receiving updated commissioning settings from the server 105 at the mobile device 103. In certain embodiments the method 400 may include transmitting the updated commissioning settings from the mobile device 103 to the HVAC system 101. Data transfer to/from the mobile device 103 and HVAC system 101 can be accomplished in any suitable manner (e.g., via a specific application, using any suitable security protocol, utilizing a user authentication and/or manual control).

In certain embodiments, the method 400 may include notifying the user of updated system settings from the server 105, displaying on the mobile device 103 the updated commissioning settings and/or diagnostic data, and/or prompting a user for approval to transmit the updated commissioning settings at the mobile device 103. For example, user notification and prompting can be accomplished by means of an application or “app” stored on and executed by the mobile device 103. The app can be a way to display notifications, system information, and confirmation requests by means of a graphical user interface (i.e., a GUI) on the mobile device 103. The app can act as a control intermediary for information exchange between the mobile device 103, HVAC system 101, and server 105. The app can include any suitable software stored on the mobile device 103 and can utilize any suitable hardware of the mobile device 103.

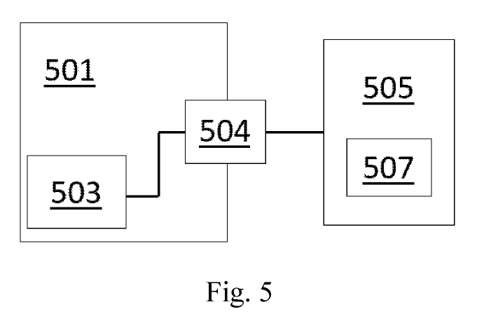

In accordance with at least one aspect of this disclosure, the HVAC system 101 can include a plurality of HVAC components (e.g., fans, heat pumps, sensors, ducting and/or the like). Referring to FIG. 5, a controller 501 for an HVAC system 101 can include a data aggregation module 503 configured to receive commissioning settings and/or diagnostic data from one or more of HVAC components. The controller 501 can include a removable dongle interface 504 configured to receive a removable dongle 505 for transmitting the commissioning settings and the diagnostic data between the mobile device 103 and the controller 501. The removable dongle interface 504 can include a wired connection (e.g., a USB port) and/or wireless receiver.

In another aspect, the controller 501 may include a settings update module for receiving updated commissioning settings from the mobile device 103. The update module is intended to “push” or forward the updated commissioning settings to at least one of the plurality of HVAC components. The controller 501 may include a removable dongle 505. For example, a removable dongle 505 can encompass any removable device that includes a wireless transmission module 507 that can transmit information between the HVAC system 101 and the mobile device 103 at the controller 501. In other embodiments, the removable dongle 505 can be a wired connection from the controller 501 to the mobile device 103.

Any suitable method, systems, and/or portions thereof as described above can be implemented via any suitable software and stored on any suitable non-transitory computer readable medium.

### Aspects

It is noted that any of aspects described below can be combined with each other in any suitable combination as is appreciated by those having ordinary skill in the art.

Aspect 1. A method for receiving commissioning settings and diagnostic data from an HVAC system at a server, and populating a database stored on the server with the commissioning settings and the diagnostic data from the HVAC system.

Aspect 2. The method may include correlating the commissioning settings and the diagnostic data with existing operational data in the database to determine an operational condition of the HVAC system.

Aspect 3. The method may include transmitting updated commissioning settings from the server.

Aspect 4. A method for establishing a connection between a mobile device and a HVAC system. The method includes receiving commissioning settings and diagnostic data at the mobile device from the HVAC system, and transmitting the commissioning settings and diagnostic data from the mobile device to a server.

Aspect 5. The method may include receiving updated commissioning settings from the server.

Aspect 6. The method may include transmitting the updated commissioning settings from the mobile device to the HVAC system.

Aspect 7. The method may include notifying the user of updated settings at the mobile device.

Aspect 8. The method may include prompting a user for approval to transmit the updated commissioning settings at the mobile device.

Aspect 9. The method may include displaying on the mobile device the commissioning settings and/or diagnostic data.

Aspect 10. The method may include establishing a connection between the mobile device and a removable dongle connected to the HVAC system.

Aspect 11. A system comprising a server includes a processor and memory. The processor configured to execute computer readable instructions stored on the memory. The instructions include receiving commissioning settings and diagnostic data from a HVAC system at the server, and populating a database stored on the server with the commissioning settings and the diagnostic data from the HVAC system.

Aspect 12. The instructions may include correlating the commissioning settings and the diagnostic data with existing operational data in the database to determine an operational condition of the HVAC system.

Aspect 13. The instruction may include transmitting updated commissioning settings from the server.

Aspect 14. A non-transitory computer readable medium including computer executable instructions. The computer executable instructions include establishing a connection between a mobile device and an HVAC system, receiving commissioning settings and diagnostic data from the HVAC system, and transmitting commissioning settings and diagnostic data from the mobile device to a server.

Aspect 15. The instructions may include receiving updated commissioning settings from the server.

Aspect 16. The instructions may include transmitting updated commissioning settings from the mobile device to the HVAC system.

Aspect 17. Establishing a connection to the HVAC system may include establishing a connection between the mobile device and a removable dongle connected to the HVAC system.

Aspect 18. The instructions may include notifying the user of updated commissioning settings at the mobile device.

Aspect 19. The instructions may include prompting a user for approval to transmit the updated commissioning settings at the mobile device.

Aspect 20. The instructions may include displaying on the mobile device the commissioning settings and/or diagnostic data.

Aspect 21. A controller for an HVAC system. The HVAC system may include a plurality of HVAC components. The controller may include a data aggregation module configured to receive commissioning settings and diagnostic data from the plurality of HVAC components, and a removable dongle interface configured to receive a removable dongle for transmitting the commissioning settings and the diagnostic data to a mobile device.

Aspect 22. The removable dongle interface may include a wired connection.

Aspect 23. The removable dongle interface may include a wireless receiver.

Aspect 24. The controller may include a settings update module for receiving updated commissioning settings from the mobile device and for pushing the updated commissioning settings to at least one of the plurality of HVAC components.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1. A method comprising:
receiving commissioning settings and diagnostic data from a HVAC system at a server; and
populating a database stored on the server with the commissioning settings and the diagnostic data from the HVAC system.

2. The method of claim 1, further comprising correlating the commissioning settings and the diagnostic data with existing operational data in the database to determine an operational condition of the HVAC system.

3. The method of claim 2, further comprising transmitting updated commissioning settings from the server.

4. A method comprising:
establishing a connection between a mobile device and a HVAC system;
receiving commissioning settings and diagnostic data at the mobile device from the HVAC system; and
transmitting the commissioning settings and diagnostic data from the mobile device to a server.

5. The method of claim 4, further comprising receiving updated commissioning settings from the server.

6. The method of claim 5, further comprising transmitting the updated commissioning settings from the mobile device to the HVAC system.

7. The method of claim 6, further comprising notifying the user of updated settings at the mobile device.

8. The method of claim 6, further comprising prompting a user for approval to transmit the updated commissioning settings at the mobile device.

9. The method of claim 4, further comprising displaying on the mobile device the commissioning settings and/or diagnostic data from the HVAC system.

10. The method of claim 4, wherein establishing a connection includes establishing a connection between the mobile device and a removable dongle connected to the HVAC system.

11. A system comprising a server, having:
a processor and memory, the processor configured to execute computer readable instructions stored on the memory, the instructions including:
receiving commissioning settings and diagnostic data from a HVAC system at the server;
populating a database stored on the server with the commissioning settings and the diagnostic data from the HVAC system.

12. The system of claim 11, wherein the instructions further include correlating the commissioning settings and the diagnostic data with existing operational data in the database to determine an operational condition of the HVAC system.

13. The system of claim 12, wherein the instructions further include transmitting updated commissioning settings from the server.

14. A non-transitory computer readable medium comprising computer executable instructions, the instructions including:
establishing a connection between a mobile device and an HVAC system;
receiving commissioning settings and diagnostic data from the HVAC system; and
transmitting commissioning settings and diagnostic data from the mobile device to a server.

15. The non-transitory computer readable medium of claim 14, wherein the instructions further comprise receiving updated commissioning settings from the server.

16. The non-transitory computer readable medium of claim 15, wherein the instructions further comprise transmitting updated commissioning settings from the mobile device to the HVAC system.

17. The non-transitory computer readable medium of claim 14, wherein establishing a connection to the HVAC system includes establishing a connection between the mobile device and a removable dongle connected to the HVAC system.

18. The non-transitory computer readable medium of claim 15, wherein the computer executable instructions further comprise notifying the user of updated commissioning settings at the mobile device.

19. The non-transitory computer readable medium of claim 14, wherein the computer executable instructions further comprise prompting a user for approval to transmit the updated commissioning settings at the mobile device.

20. The non-transitory computer readable medium of claim 14, wherein the computer executable instructions further comprise displaying on the mobile device the commissioning settings and/or diagnostic data.

21. A controller for an HVAC system, the HVAC system including a plurality of HVAC components, the controller comprising:
a data aggregation module configured to receive commissioning settings and diagnostic data from the plurality of HVAC components; and
a removable dongle interface configured to receive a removable dongle for transmitting the commissioning settings and the diagnostic data to a mobile device.

22. The controller of claim 21, wherein the removable dongle interface includes a wired connection.

23. The controller of claim 21, wherein the removable dongle interface includes a wireless receiver.

24. The controller of claim 23, wherein the wireless receiver includes at least one of a wifi receiver or a Bluetooth receiver.

25. The controller of claim 21, further comprising a settings update module for receiving updated commissioning settings from the mobile device and for pushing the updated commissioning settings to at least one of the plurality of HVAC components.

26. The controller of claim 21, further comprising the removable dongle.

27. A method comprising:
establishing a connection between a mobile device and a HVAC system;
receiving commissioning settings and diagnostic data at the mobile device from the HVAC system; and
displaying on the mobile device the commissioning settings and/or diagnostic data.
